(19) United States
(12) Patent Application Publication
(10) Pub. No.: US 2008/0288401 A1
(43) Pub. Date: Nov. 20, 2008

(54) Commercial self-service electronic cash transfer transaction system "person to person debit transfer system"

(76) Inventors: Geniva Forrestine Jones, Richmond, VA (US); Tom Jones, JR., Tuscaloosa, AL (US)

Correspondence Address: Geniva Forrestine Jones, #423, 806 Brook Hill Rd, Richmond, VA, 23227, US

(21) Appl. No.: 12/152,224

(22) Filed: May 13, 2008

Related U.S. Application Data
(60) Provisional application No. 60/930,058, filed on May 14, 2007.

(51) Int. Cl. G06Q 40/00

(52) U.S. Cl. 705/43

(57) ABSTRACT

Disclosed is a system for transferring funds from ATM to ATM by performing a Debit Transfer transaction. The system provides the consumer with an alternative service for making a money transfer. Today, there is no commercial self-service electronic process in the market that enables the consumer to perform a money transfer transaction electronically directly from ATM to ATM. With Person-to-Person Debit Transfer System money can be sent from an ATM by a Cardholder and the recipient being an “unbanked” customer can pick up the funds without any type of credit card. The present invention provides a method for quick cash for emergencies for family members, business associates, students and “unbanked” customers.

### CROSS REFERENCE TO RELATED APPLICATIONS

This application claims priority from Provisional Applications No. 60/930,058 filed May 14, 2007.

### BACKGROUND OF THE INVENTION

1. Field of the Invention

The present invention relates generally to financial electronic debit transfer transactions. This invention pertains to an enhancement for electronic money transfer transaction system comprising elements such as a bank center, a bank ATM (automatic teller machine), independent ATM center, Bankcard, Credit Card, IC Card, Smart Card, Money Card and ATM Cards used for the convenience of making electronic funds transfer transactions. More specifically, its key method of operation is electronically transferring money from one ATM (automatic teller machine) to another ATM (automatic teller machine).

2. Related Art

Heretofore, credit cards, automated teller machine hereafter “ATM” cards and so called smart cards have been used to debit funds from bank accounts or cardholder accounts. Presently a certain amount of money can be withdrawn from a cardholders account directly from an ATM or immediately after making a store purchase simply by selecting debit and entering a pin number. Unfortunately, the cardholder currently can not send money or transfer money from their account by giving a direct electronic link to their account by way of ATM to ATM. Therefore, allowing the receiver access to the cardholders account by a commercially pre-approved self-service electronic debit transfer process, this enables money to be sent from in-state, out of state, or out of the country electronically by ATM.

In view of the foregoing, there is a need for a process and system(s) for conveniently conducting money transfers transactions without the unnecessary delays, costly transaction fees due to lost funds, delayed refund policies and hidden service fees linked to the use of Money Cards.

### BRIEF SUMMARY OF THE INVENTION

In a first general aspect of the present invention is provided a method the steps of accessing one financial account at one financial institution ATM (Automatic Teller Machine) performing a debit transfer transaction, during this transaction transmitting an account access approval by using an ATM that electronically generates a transaction code (password), entering the amount to be debit, selecting the state of the receiver and printing a transaction receipt. The present invention provides a number of advantages over other money transfer systems that exist today. First the process allows the sender (cardholder) to be totally in control of the financial electronic debit funds transfer transactions. The sender selects the account that the money should be debit from and the amount to be debit. Another of the advantages is that the cardholder now has the capability to know first hand if the money was received and if not, to have complete access to the funds without any delay. The third advantage is a flat rate transaction fee that is subtracted by the bank or independent ATM owner. The transaction fees generated provides each financial institution with an opportunity to profit. Usage of the present invention could ultimately lead to a new standard for performing an electronic transfer of funds.

In a second general aspect in accordance with the present invention is provided the current method for transferring money that is used by the cardholder. At the present a cardholder must do one of the following to send money in-state, out of the state or out of the country: purchase a money order, purchase a cashier check, transfer money between accounts of bank members, send a money wire transfer or purchase a prepaid money card. Today, there is no commercial self-service electronic process in the market that presents an integrated module that enables the user to perform a money transfer transactions electronically directly from ATM to ATM.

A third general aspect of the present invention provides a system for performing money transfer transactions electronically directly from ATM to ATM. With Person-to-Person Debit Transfer System the cardholder (sender) can conveniently send money to anyone 24 hours a day, 7 days a week directly from a Bank ATM location or an independent ATM location example includes Wal-Mart, convenience stores, grocery stores, retail shops, credit unions, college campus ATM stations, airports, hotels, hospitals and virtually wherever an ATM is made available to consumers. The recipient being a banked consumer or an (“unbanked”) consumer meaning one who is not a member of a bank, does not have a credit card account and is not a cardholder, can pickup the funds within seconds 24 hours a day 7 days a week at any ATM location. The cardholder transaction code (password) is electronically generated and printed on each transaction receipt, which will allow the receiver access to the senders account; once a transaction code is generated from a debit transfer transaction this will electronically transmit an account access approval. The sender (cardholder) account has a pending transaction, holding the funds to be transferred in the cardholder's account until the recipient completes the transaction. Allowing the recipient access to the sender's account for a (72-hour period), with the capability of withdrawing funds that were sent as a debit transfer transaction. Sending a money wire transfer can be time consuming with the amount of paperwork that has to be filled out, costly with the high fee structure to provide the service and uncertain with some service providers. There are a number of disadvantages of sending a money wire transfer. First, reading length agreements and standing in long lines. Secondly, no control over the transaction code (password) being forward incorrectly by a clerk. Third, is lost of funds and a 30 to 60 day delay refund policy.

There are a number of disadvantages of using a prepaid debit card to transfer funds in cases when funds are needed immediately. First, there is a 5-7 day wait to receive a card. Secondly, it will take 5-7 days or more for a card to reach a recipient by standard mail. Third, are the monthly fees charged to be a cardholder along with hidden service fees.

With Person-to-Person Debit Transfer System the money is coming directly out of the senders (card holder) account, money will always be on time, the receiver can pickup the funds immediately or at their on convenience, funds will never be lost or delayed; if receiver decides not to pickup the funds-the money remains in the senders (card holder) account. Overall, cash will always be used though out the world. Immediate availability to funds will always be beneficial to the consumer as well as, retailers.

### BRIEF DESCRIPTION OF THE SEVERAL VIEWS OF THE DRAWING

FIG. 1 is a block diagram of a conventional ATM System using a Bank ATM Debit Card, representing sending an Electronic Funds Person-to-Person Debit Transfer process, based on an Initial ATM Server Interface module for the Send and Receive funds for a Debit Transfer.

The Initial ATM Server Interface module 01, will initialize the state of the Bank ATM 03 or Independent ATM 03, so that it is waiting on an ATM card or the Debit Transfer button to be pressed. The cardholder (sender) 02, who has a bank card(s) such as a Bank ATM Card, Credit Card, Prepaid Money Card, IC Card, Debit Card, or Smart Card. That can be used to debit funds from bank account(s) or cardholder account(s) by using a Bank Center ATM or Independent ATM 01. For this description the cardholder will be performing a Person-to-Person Debit Transfer at a Bank Center ATM (e.g. SunTrust ATM) and transferring the money using a Bank Debit Card (e.g. SunTrust Debit Card.)

The sender 02 will insert the card into the ATM 03, enter their PIN 04 from the number keypad on the ATM 03 thereafter, the ATM 03 screen display a Main Screen with options that reads e.g. Balance Inquire, Cash with Receipt, Deposit, Debit Transfer. The sender will choose Debit Transfer 05 by using the ATM 03 designated button. After selecting the Debit Transfer button, the ATM 03 screen displays two account options (Checking or Savings). These self-service ATM (Automatic Teller Machine) account options in general are already known in this diagram. The cardholder will select the designated button to the account used for this Debit Transfer Transaction. For this description the cardholder will be transferring money from their (e.g. Checking Account). Debit Transfer 05 is generated by the new integrated server interface module.

The ATM 03 screen now displays “Send Debit Transfer” and the option that reads “Enter the amount to be sent” 06, both are generated by the new integrated server interface module. The sender will enter the amount to be Transferred 06 e.g. $400.00 by using the ATM 03 number keypad. After keying the amount to be sent the ATM 03 screen will display the amount entered. The sender will select enter to continue the process.

The ATM 03 screen will display the transaction fees notice that is generated by the new integrated module that reads “There will be an e.g. $15.00 transaction fee subtracted from your account for using this service” 07. The ATM 03 screen will also display options that read “would you like to continue?” “Yes or No” The ATM 03 screen displays a separate designated button for “Yes” and “No”. The sender will select “Yes” 07. By selecting yes the sender authorizes the transaction fee to be subtracted from their account.

The ATM 03 displays a State Code screen listing all 51 states 08, each showing a two digit code prefixed for each state. The sender selects the state where the money is being transferred to. By using the ATM 03 number keypad the sender will enter the two digit code e.g. 47-Virginia 09. The ATM 03 screen will display the two digit code entered by the sender. The sender will select enter to continue the process. The complete State Code screen is apart of the new integrated server interface module.

Thereafter, the ATM 03 screen will display the following: an authorization that reads “Debit Transfer has been authorized” 10. The funds that were Debit are now in the cardholder's (sender) account as a Pending Transaction. Holding the debit amount in the account until the recipient completes the transaction on their end 10. There is a recipient instruction that reads “The recipient will need the following: The Transaction Code and The Sent Amount in order to receive the funds 10.”

Also the ATM 03 screen displays the transaction expiration date that reads “This transaction will expire on e.g. May 13, 2008 (72-hour period) 10.” The sequence of the authorization functions is apart of the new integrated server interface module. At any time after starting the Debit Transfer process the sender has the option to cancel the transaction.

More transactions can be made 11. Final information on ATM 03 screen displays the following “Would you like to perform another transaction?” 11. The options read “Yes or No” The ATM 03 screen displays a separate designated button for “Yes” and “No”. If the sender selects “No” the Person-to-Person Debit Transfer is completed on the sender's end. A receipt is generated by the ATM 03 machine and printed. The electronic Transaction Code (password) e.g. 12345678 is automatically generated by the new integrated server interface module and printed onto the receipt by the ATM 03.

Cardholder contacts recipient 02 e.g. by phone or e-mail and relay to them the Transaction Code e.g. 12345678, the Sent Amount e.g. ($400.00) 10 and Bank Center ATM used for this transaction e.g SunTrust ATM 03.

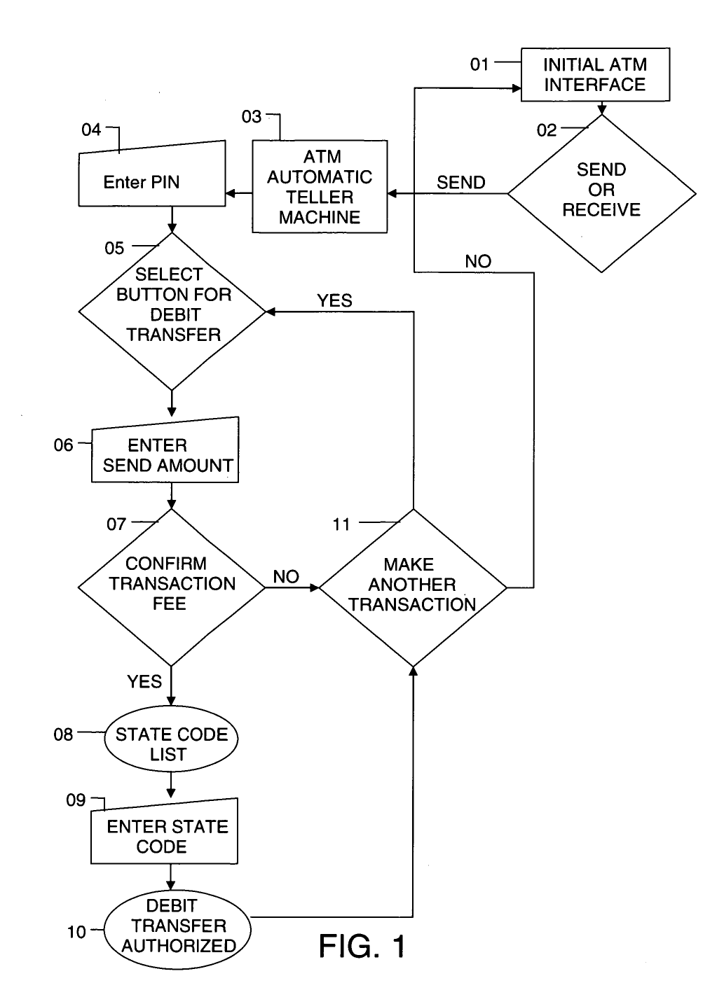

More transactions can be made 11. Final information on ATM 03 screen displays the following “Would you like to perform another transaction?” 11. The options read “Yes or No” The ATM 03 screen displays a separate designated button for “Yes” and “No”. If the sender selects “Yes” the Main Screen will display with options that reads e.g. Balance Inquire, Cash with Receipt, Deposit, and Debit Transfer 05. If the cardholder chooses to create another Debit Transfer 05 transaction, accessing the process would be the same steps as shown in FIG. 1.

FIG. 1 is a block diagram of a conventional ATM System being used by an (unbanked) consumer without a Bank ATM Debit Card, based on an Electronic Funds Person-to-Person Debit Transfer withdrawal process.

As explained in the description of FIG. 1, recipient (receiver) 02 receives call from cardholder (sender) 02 relaying the Transaction Code e.g. 12345678, the Sent Amount e.g. ($400.00) 10 and Bank Center ATM used for this transaction e.g. SunTrust ATM 03. The recipient goes to an e.g. SunTrust ATM 03. The e.g. SunTrust ATM 03 initial screen displays the following options that reads “Please insert card to begin or Press Debit Transfer button to receive funds” 12. These options are generated by the new integrated module. The recipient selects the “Debit Transfer button to receive funds” 12.

The SunTrust ATM 03 screen displays the following: “Receive Debit Transfer” along with an option that reads “Enter Transaction Code” 13. The recipient enters the Transaction Code e.g. 12345678 from the number keypad on the SunTrust ATM 03. The SunTrust ATM 03 screen will display the Transaction Code that the recipient entered. The recipient selects enter to continue the process.

The SunTrust ATM 03 will display the following option that reads “Enter Amount to Receive” 14. The recipient enters the Amount Sent e.g. ($400.00) 14. The SunTrust ATM 03 screen will display the amount entered. If correct, the recipient selects enter to continue the process. The newly integrated module will verify the data 15 that was entered by the recipient 02. After verifying the data the newly integrated module server interface will “Process the Transaction” 16. The ATM 03 screen displays “Transaction Complete, Funds Will Be Dispensed Below” and “Thank You for Using Person-to-Person Debit Transfer.” 17 The SunTrust ATM 03 dispenses $400.00 cash to the recipient 17. At any time after starting the withdrawal process the recipient has the option to cancel the transaction.

If the “Transaction Code” data is entered incorrect 18 or the “Amount to Receive” is entered incorrect 18 the screen will display “Transaction Failed, Problem Occurred Retrieving Funds Due To: Code: 21, Message: Invalid Information Entered. Please Try Again” 18. The recipient must enter both, the “Transaction Code” and the “Amount to Receive,” correctly in order for the transaction to be process and completed. Therefore, the recipient will be prompted to re-enter the “Transaction Code” 13 and the “Amount to Receive” 14. This process is controlled by the new integrated module server interface.

While Applicants have set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

The invention claimed is:

1. A system for providing ATM to ATM self-service electronic cash transfer transactions Person to Person Debit Transfer comprising: (a) an independent software application (ISA) server module designed to interface with ATM (Automatic Teller Machine) of different manufacturers. Wherein the (ISA) module enables an ATM to ATM Transfer of Funds Transaction to be requested as a Debit Transfer of Funds Transaction, (b) wherein the (ISA) module enables the ATM to carry out a Debit Transfer request for cash withdrawal transaction as a hold (pending) transaction for the transferred amount on an account, (c) wherein the (ISA) module enables a Transaction Fee to be subtracted from an account, (d) wherein the (ISA) model request the state code of the recipient a listing of each state code is generated for display and proper entry, (e) wherein the (ISA) model interface displays a recipient notification and a Debit Transfer expiration date, (f) wherein the (ISA) module interface responsive to an approved request automatically generates a Transaction Code (password) and print it onto the ATM receipt, (g) wherein the (ISA) module enables the ATM to carry out a Debit Transfer withdrawal of the hold (pending) transaction, (h) wherein the (ISA) enables a Debit Transfer withdrawal to be requested with the ATM without a debit card, credit card, money card, or smart card, (i) wherein the (ISA) enables a Debit Transfer withdrawal by entering the Transaction Code (password) and the approved transferred amount to receive the cash withdrawal Debit Transfer requested, (j) wherein the ATM display screen displays the (ISA) adapted screens for the Debit Transfer request and the Debit Transfer withdrawal transactions and a method of operation for the (ISA) module requires that each action performed the information is sent to the server, (k) wherein the (ISA) Initial ATM Server Interface method of operation contain adaptations, security modifications and can operate interfaced with a Web server and ATM server.

2. This method according to claim 1, wherein (a) includes an independent software application (ISA) server module interface to be installed on an automatic teller machine server; that will initialize the state of the ATM display screen so that it is waiting on an ATM card or the Debit Transfer button to be pressed. ATM displays Enter PIN, the screen display banking options that include the general banking options that are displayed on an ATM along with a Debit Transfer option, wherein the Debit Transfer option is selected.

3. This method according to claim 1, wherein (b) the (ISA) module enables the ATM to carry out a Debit Transfer request for cash withdrawal transaction as a hold (pending) transaction for the transferred amount on an account, wherein the ATM screen display Send Debit Transfer and enter the amount to be sent, wherein after entering the amount to be sent following this action the ATM screen will display withdrawal banking options for checking and savings account, wherein by selecting an account a transaction fee will apply.

4. This method according to claim 3, wherein (c) the (ISA) module enables a Transaction Fee to be subtracted from an account, wherein the (ISA) enables the ATM to initialize the system to the choose screen that will display the transaction fee notice, wherein the options the ATM screen will display yes, if agree to pay the transaction fee and no, if refuse to pay the transaction fee, wherein selecting yes, this action will forward the process to the next step, wherein selecting no, this action will cancel the transaction.

5. This method according to claim 1, (d) wherein the (ISA) model request the state code of the recipient a listing of each state code is generated for display and proper entry, wherein the (ISA) enables the ATM to display a listing of all 51 states with a prefix numerical code, wherein the prefix numerical code of the recipient must be entered, wherein entering the state code to indicate which state the money (Debit Transfer) will go, wherein this action performed will cause the recipient notification to display on the ATM screen.

6. This method according to claim 5, (e)wherein the (ISA) module interface displays a recipient notification and a Debit Transfer expiration date, wherein the ATM display screen will display to say Debit Transfer has been authorized. The recipient will need the following: Transaction Code and The Sent Amount in order to receive the funds; this transaction will expire on: May 13, 2008, wherein the (ISA) module interface will allow variable settings for the pending transaction expiration date, wherein the ATM screen will display the following under the recipient notification; would you like to perform another transaction? Wherein the options the ATM screen will display yes, if another transaction is to be made and no, if no more transaction are to be made, wherein selecting yes, this action will take you back to (a) the screen display banking options that include the general banking options that are displayed on an ATM along with a Debit Transfer option, wherein selecting no, this option will complete the transaction and (f) wherein the (ISA) module interface responsive to an approved request automatically generates a Transaction Code (password) and print it onto the ATM receipt.

7. This method according to claim 6, (f) wherein the (ISA) module interface responsive to an approved request automatically generates a Transaction Code (password) and print it onto the ATM receipt, wherein one receipt is printed responsive to a Debit Transfer being generated the (ISA) module interface will allow variable settings responsive to the Debit Transfer withdrawal, wherein a receipt is printed after a Debit Transfer withdrawal, wherein the variable settings are actively responsive to the Debit Transfer being generated to secure the consumer personal banking data.

8. This method according to claim 1, (g) wherein the (ISA) module enables the ATM to carry out a Debit Transfer withdrawal of the hold (pending) transaction, wherein after sending a Person-to-Person Debit Transfer the new integrated single transaction code will process the ATM transaction as a hold (pending transaction) for the transferred amount on the selected account, wherein the Debit Transfer cash withdrawal was requested.

9. This method according to claim 1, (h) wherein the (ISA) enables a Debit Transfer withdrawal to be requested with the ATM without a debit card, credit card, money card, or smart card, wherein with the (ISA) module the new integrated single transaction code will control operating the ATM without any type of money cards, debit card, credit card, or smart card, wherein the (ISA) server interface enables the ATM to initialize the state of the ATM display screen so that it is waiting on an ATM card or the Debit Transfer button to be pressed, wherein the Debit Transfer button will be pressed and the screen will change over to display a Welcome screen that says Receive Debit Transfer; Enter the Transaction Code, wherein the transaction code must be entered correctly to forward the process to the next step, wherein after completing this action the display screen will display Enter the amount to receive, wherein the amount must be entered correctly to forward the process to the next step, wherein entering the wrong transaction code, amount to receive or both the (ISA) interface sends the information to the server, wherein the server returns an error message and ATM screen displays Transaction Failed: Invalid Information Entered; Please try again.

10. This method according to claim 6, (i) wherein the (ISA) new integrated single transaction code enables a Debit Transfer withdrawal with the ATM by entering the Transaction Code (password) and approved transferred amount to receive the cash withdrawal Debit Transfer requested, wherein the ATM currency dispenser dispense the cash on hold from the (pending transaction) transferred amount, wherein the cash withdrawal makes the Debit Transfer a Person-to-Person transaction.

11. This method according to claim 1, (j) wherein the ATM display screen displays the (ISA) adapted screens for the Debit Transfer request and the Debit Transfer withdrawal transactions and a method of operation for the (ISA) module requires that each action performed the information is sent to the server, wherein this method represents a server interface that will interface with the ATM server, wherein with the (ISA) module server interface is connected to the ATM server the ATM is operative to send a Debit Transfer transaction and Receive a Debit Transfer withdrawal.

12. This method according to claim 11, (k) wherein the (ISA) Initial ATM Server Interface module method of operation contain adaptations and can operate its server interface with a Web base Internet Banking server and ATM server, wherein the (ISA) module server interface includes modifications enabling ATM servers to operate without compromising security.
